(19) United States
(12) Patent Application Publication
(10) Pub. No.: US 2005/0030288 A1
(43) Pub. Date: Feb. 10, 2005

(54) Portable and ergonomic computer input device

(76) Inventor: Jeffrey Johnson, Woodland Hills, CA (US)

Correspondence Address: Aaron T. Borrowman;Kelly Lowry & Kelley, LLP, Suite 1650, 6320 Canoga Avenue, Woodland Hills, CA, 91367, US

(21) Appl. No.: 10/910,083

(22) Filed: Aug. 2, 2004

Related U.S. Application Data
(60) Provisional application No. 60/493,068, filed on Aug. 5, 2003.

(51) Int. Cl. G09G 5/08

(52) U.S. Cl. 345/167

(57) ABSTRACT

A portable and ergonomic computer cursor and control input device includes a generally deformed, substantially cylindrical sidewall extending upwardly from a base. The sidewall is dimensioned in contour to enable a palm of a user to be disposed substantially vertical with respect to the base such that the user's fingers form a generally vertical stack when the sidewall is grasped by the user, maintaining the hand and wrist of the user in a relaxed, untwisted and naturally upright position. One or more pointer and cursor control member actuators are operably mounted to the sidewall adjacent to the user's thumb or fingers for selectively moving the cursor and entering commands.

### RELATED APPLICATION

This application claims priority to U.S. Provisional Application Ser. No. 60/493,068, filed on Aug. 5, 2003.

### BACKGROUND OF THE INVENTION

The present invention generally relates to computer cursor control and input devices, typically referred to as a mouse. More particularly, the present invention relates to a portable computer input device that comfortably fits in the hand of the user and which allows control of the cursor while not constrained to a horizontal surface.

Many software programs use movable cursors for selecting data and objects or drawing on a display monitor. The cursors are generally controlled by manually manipulating an input device or pointing device connected to a computer. Common pointing devices include the mouse, track ball, touch pad and digitizing tablet.

The mouse is the most popular input pointing device. It typically includes a housing that is slidably moved about on a flat, stationary surface. The housing contains a motion sensor on its bottom side for tracking its movement, and one to three buttons on its front edge and electronic circuitry for communicating with an attached computer. When the mouse is moved about, the cursor moves in corresponding directions either due to a laser beam which is moved in direction, or a track ball which is rotated as the mouse is moved along the horizontal surface. As the mouse is moved about, the cursor moves in corresponding directions; and when the buttons are pressed, certain actions can be performed, depending on the software application using the mouse.

Most mice are usually substantially wider than they are tall, and have generally symmetrical sides so that they can be used by either the right or the left hand. Some mice, such as that shown in U.S. Pat. No. D328,597 to Clouss, are slightly angled so as to be adapted for use of a particular hand, such as the right hand of the user. Still some other mice are somewhat ergonomically-shaped, such as those shown and described in U.S. Pat. No. 4,862,165 to Gart, U.S. Pat. No. 5,414,445 to Kaneko et al.

However, all of these devices are typically low profile and require the palm of the user's hand to face generally downward in operation of the mouse or pointing device, which can create undue strain on the muscles, tendons and joints of the user's hand and arm. Prior art devices which are generally horizontal, so as to support a hand in a horizontal position, force the hand, wrist and forearm to be twisted 80 to 90° out of their natural and relaxed positions, and require constant muscular force to be applied to the hand, wrist and forearm to maintain their positions. For a three-button mouse, the forefinger, middle finger and ring finger must be kept in constant tension to prevent them from resting too heavily on the buttons and depressing them inadvertently. A horizontal hand holding a prior art mouse is supported on a desk by only a small area at the wrist on the little finger side, so that a pressure sore may develop thereon.

Although the total effort and discomfort may not seem great at first, the wrist and arm are subjected to a constant degree of dorsal radial and ulnar flexion, and at times unnatural lateral wrist movements, and over a long and prolonged and continued use of time, users may experience fatigue, discomfort, and even pain in the hand and wrist which can lead to mouse related repetitive injuries such as tendinitis, bursitis and carpel tunnel syndrome. Even the most advanced ergonomic designs of such low profile devices do not address these problems satisfactorily.

The most natural and relaxed position for a hand is in an upright position with the little finger of the hand resting on the desk or positioned at the lower most point and the fingers and palm generally positioned along a vertical plane.

Other pointing devices, such as those illustrated and described in U.S. Pat. No. 5,576,733 to Lo, and U.S. Pat. No. 5,894,303 to Barr are more upright in nature such that the computer operator can hold the device in more of a natural upright manner. However, these pointing devices also require a flat surface for operation as the base of each of these devices includes a track ball to be rotated upon the horizontal surface for moving the cursor or a laser beam, and otherwise controlling the computer.

Accordingly, there is a continuing need for a computer input pointing device which is ergonomic so as to comfortably fit in the hand of the user. The device should also be portable as to not be constrained to operation on a flat surface, but rather include the necessary buttons, track ball or scrolling wheel which are actuated by the user's fingers and thumb and which can be actuated remotely, e.g. while sitting in a chair removed from the computer screen. The present invention fulfills these needs and provides other related advantages.

### SUMMARY OF THE INVENTION

The present invention resides in a portable and ergonomic computer cursor control and input device which is ergonomic so as to comfortably fit into the hand of the user. The device is also portable so as not to be constrained to operation on a flat surface, but instead can be held at any desired position away from the computer monitor, such as while sitting in an arm chair or the like.

The device of the present invention generally comprises a base having a generally deformed, substantially cylindrical sidewall extending upwardly therefrom. The sidewall's dimension and contour enable a palm of a user to be disposed substantially vertical with respect to the base such that a user's fingers form a generally vertical stack, with the index finger at the top thereof and a little finger at the bottom thereof when the sidewall is grasped by the user. In a particularly preferred embodiment, the base is substantially planar flat to support the device on a horizontal surface.

A pointing member actuator for moving the cursor is operatively mounted in the sidewall adjacent to the user's thumb. The pointing member actuator typically comprises a track ball operably mounted in the side wall.

A depression is preferably formed in the sidewall surrounding the pointing member track ball actuator and configured to accept at least a portion of the user's thumb therein. Finger depressions may also be formed in the side wall and positioned and configured to receive at least a portion of the user's fingers thereof for support and comfort.

In a particularly preferred embodiment, a scroll wheel is also mounted in an upper portion of the sidewall adjacent to the index finger of the user. At least one depressable button switch is mounted on the side wall above and/or below the scroll wheel so as to be adjacent to an index finger or middle finger, respectively, of the user.

Although the device may include a cable extending therefrom directly to the computer, in a particularly preferred embodiment the device is configured for wireless communication with a computer. Thus, the hand and wrist of the user is maintained in a relaxed, untwisted and naturally upright position and the computer user is not limited to operation of the device on a flat surface.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of an ergonomic computer cursor control and input device embodying the present invention, with an open user's hand shown in phantom;

FIG. 2 is a side perspective view similar to that in FIG. 1, illustrating the user's hand in a grasped, operating position on the device;

FIG. 3 is a side perspective view of the device, similar to FIG. 1;

FIG. 4 is an end elevational view of the device of the present invention, illustrating a track ball extending from a sidewall thereof;

FIG. 5 is a side elevational view, illustrating a track ball of the present invention; and

FIG. 6 is a side elevational view, illustrating a scroll wheel, control buttons and finger depressions formed in the sidewall thereof.

### DETAILED DESCRIPTION OF THE PREFERRED EMBODIMENT

As shown in the accompanying drawings, for purposes of illustration, the present invention resides in an ergonomic and portable computer cursor control and input device, generally referred to herein by the reference number 10. As will be discussed more fully herein, the input device 10 of the present invention is designed with careful attention to ergonomic factors, particularly towards minimizing stress in the user's fingers, wrist, forearm, shoulder and neck. The device 10 is also not restricted to use on a flat and horizontal surface, allowing the use of the input device over long periods of time without discomfort to the user.

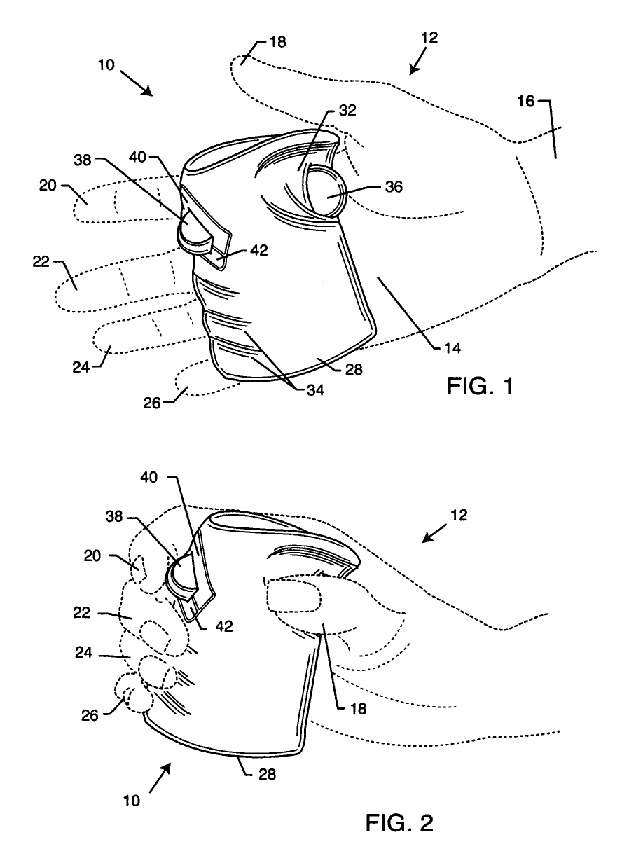

As shown in the accompanying drawings, unlike prior art mice, which are held with a horizontal hand held generally parallel to a desk, the ergonomic computer input device 10 of the present invention is held with a hand 12 of the user in a generally upright position, as illustrated in FIGS. 1 and 2. Placement of one's hand in a more vertical orientation, with a palm 14 facing right or left as shown in FIGS. 1 and 2, is more natural and relieves stress and tension on various muscles, tendons, etc. from the hand to the shoulder and neck of the user. When the hand 12 is in a relaxed, neutral, such as a cupped, position, the operating hand 12, and wrist 16 are maintained in what is referred to a radial-ulnar deviation plane, with the forearm of the user maintained in a neutral state, reducing substantially the operating effort of the operator and user of the device 10. The result is similar to grasping a can of soda or the like, with the user's thumb 18 grasping one side of the device 10, and the index or forefinger 20, middle finger 22, ring finger 24, and small or pinky finger 26, generally vertically stacked in relation to one another, as illustrated in FIG. 2.

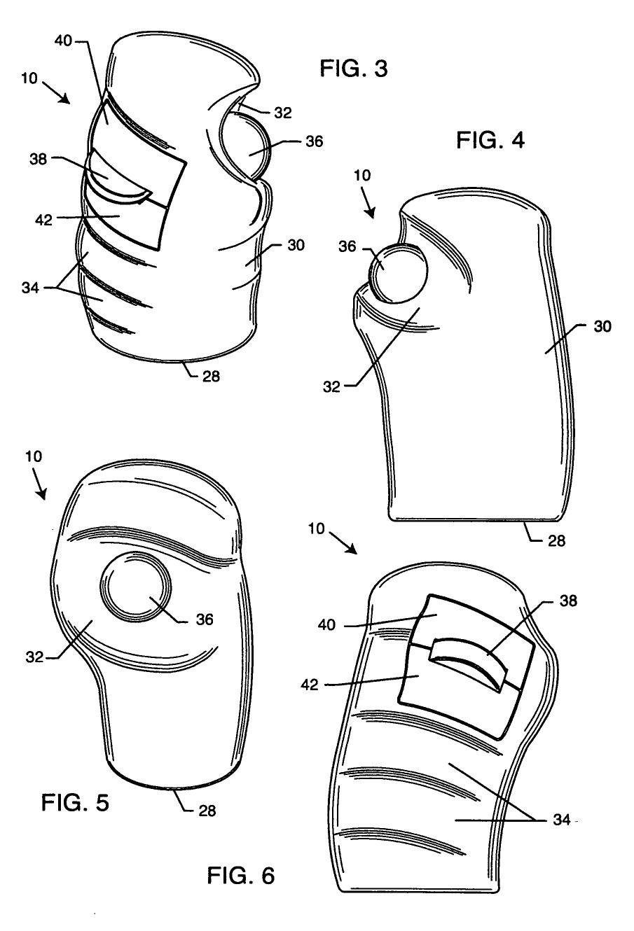

With reference now to FIGS. 3 and 4, the device 10 is comprised of a base 28 which is preferably substantially planar flat, as shown in FIG. 4, so as to be placed on a horizontal surface. This enables the user to store the device 10 on one's desk or the like, and even use the input device 10 when at the keyboard, etc., as the device 10 is placed and disposed on the flat surface adjacent the keyboard.

A generally cylindrical sidewall 30 extends upwardly from the base. The sidewall is dimensioned and contoured so as to enable the palm 14 of the user's hand 12 to be disposed substantially vertical with respect to the major plane of the base 28, such that the user's fingers 20-26 form a generally vertical stack with the index finger 20 at the top thereof and the little finger 26 at the bottom thereof when the sidewall 30 is grasped by the user.

The sidewall 30 is somewhat deformed so as to be ergonomic in nature. In particular, a generally concave depression 32 is formed in the sidewall 30 which is sized and configured so as to receive at least a portion of the user's thumb 18 therein in supportive fashion. Finger depressions 34 are also formed in the sidewall 30 such that the user's fingers 22-26 can be at least partially inserted therein and somewhat supported thereby to minimize sliding of the hand 12, and improve the grasp of the device 10. Of course, it will be appreciated that such recesses 32 and 34 are merely ergonomic in nature and intended to render the device 10 comfortable in use. The actual operation of the device does not require such recesses 32 and 34.

Although the examples shown in the accompanying drawings is a right-handed device, a left-handed version can be easily made by simply providing a mirror image of it, as will be appreciated by those skilled in the art.

The device 10 includes means for moving the computer cursor, such as a pointing member actuator. In the illustrated preferred embodiment, the pointing member actuator comprises a track ball 36 operably mounted within the sidewall 30, and extending slightly for manual operation by the user's thumb 18. As with other well-known track ball type input devices, a rotatable ball 36 is exposed for manipulation by user's thumb 18 and ball-movement signals are generated corresponding to the movement of the ball 36, and a cursor on a computer screen is moved in a direction and by an amount corresponding to the movement of the ball 36. The rotatable ball 36 may be sensed by any conventional mechanical or optical sensing system or any other desired technique. For example, if a mechanical system is used, the ball 36 may be supported on a pair of perpendicular rollers. If an optical sensing system is used, a light source may be reflected off of a portion of the ball, and an optical sensor may determine the relative movement of the ball 36.

The input device of the present invention, may include a cable (not shown) for communicating directly with the computer so as to control the movement of the cursor on the computer monitor. However, in a particularly preferred embodiment, the device can operate utilizing wireless technology, such as a radio frequency signal or “Blue Tooth” technology such that the computer operator/user can be distanced from the computer monitor, such as while leaning in a desk chair, and manipulate the cursor on a computer screen provided the input device 10 is within the range of the associated wireless technology. As such, at a minimum, the input device 10 would include a transmitter and the computer would include a receiver for receiving electronic signals generated by the device 10. Unlike other portable devices which utilize an infrared beam or gyroscope or the like, such that as the device itself is moved, the cursor is moved, the present invention only moves the cursor in response to actuating the relative pointer member, such as the aforementioned track ball 36. This enables the user to move freely about without changing the position of the cursor until intentionally doing so.

In a particularly preferred embodiment, as illustrated in FIGS. 1-3 and 6, the input device 10 also includes a scroll wheel 38. The roller or wheel 38 protrudes from the sidewall 30 adjacent to where the user's forefinger or middle finger 20 and 22 would be positioned. As the roller 38 is rotated by the user's finger 20 or 22, an electronic signal is generated for scrolling through a window displayed on the computer, thus moving the cursor to the window “scroll bar” and thus serving as a “scrolling wheel”, as is well known in the art. This enables the computer user to scroll through pages of the screen in a vertical fashion, as is well known in the art. The wheel 38 may be of any desired type, for example, it may be supported on an axle which resides within the sidewall 30 of the input device 10. Optical and/or mechanical sensors detect the movement of the wheel 38 in a conventional manner and a signal is processed and provided which correlates the rotation of the wheel 38 such that the image on the computer monitor is scrolled by a corresponding amount.

At least one input button or switch 40 is provided. This button or switch 40 provides a signal that is “primary” for most software programs, so as to select certain images, highlight, etc. Preferably, the device 10 includes at least a second input button or switch 42 to perform such functions, such as “right clicking” or “secondary” signals for most software programs.

In the particularly preferred illustrated embodiment, the first and second depressible button switches are mounted in an upper portion of the sidewall 30 so as to be adjacent to the index and middle fingers 20 and 22. In particular, the buttons 40 and 42 reside above and below, respectively, the scroll wheel 38 such that the primary button 40 can be actuated by the user's index finger 20, and the secondary button 42 can be operated by the user's middle finger 22. This enables independent actuation by tactile pressure on the respective button or switch 40 and 42 by the index finger or middle finger 20 or 22, respectively, as desired.

Thus, it will be appreciated by those skilled in the art that the input device 10 of the present invention can be used when the user is sitting in front of and adjacent to a computer monitor and working on a keyboard, for example, such that the user can grasp the device input 10 positioned on the desk or other flat surface adjacent to the keyboard and manipulate the cursor and program utilizing the pointing member actuators 36-42, as described above. Alternatively, the computer user can be distant from the computer monitor and hold the input device 10 in any desired and comfortable position while still controlling the cursor or other aspects of the program by rotating the track ball 36, scroll wheel 38, or depressing switches 40 and 42, for instance. Thus “off-desk” operation is also achieved in a more natural manner allowing unrestricted movement of the device during operation and reducing the number of injuries associated with typical mouse repetitive stress injuries.

Of course, it will be appreciated that the actuator 36-42 comprising the pointing members can be replaced with other actuators, or some even eliminated completely, or added to the device 10, as necessary. Thus, the device 10 may include three depressible switch buttons, may eliminate the scroll wheel 38, replace the track ball 36 with another pointing mechanism, or the like, while still being within the spirit of the present invention.

Although an embodiment has been described in detail for purposes of illustration, various modifications may be made without departing from the scope and spirit of the invention. Thus, the invention is only limited by the appended claims.

1. A portable and ergonomic computer cursor control and input device, comprising:
a base;
a generally deformed, substantially cylindrical side wall extending upwardly from the base, the side wall being dimensioned and contoured to enable a palm of a user to be disposed substantially vertical with respect to the base such that the user's fingers form a generally vertical stack with the index finger at a top thereof and the little finger at a bottom thereof when the side wall is grasped by the user; and
a pointing member actuator for moving the cursor operably mounted in the side wall adjacent to the user's thumb or index finger;
whereby the hand and wrist of the user is maintained in a relaxed, untwisted and naturally upright position.

2. The device of claim 1, wherein the base is substantially planar flat for supporting the device on a flat horizontal surface.

3. The device of claim 1, wherein the device is configured for wireless communication with a computer.

4. The device of claim 1, wherein the pointing member actuator comprises a track ball operably mounted in the side wall.

5. The device of claim 1, including a scroll wheel mounted in an upper portion of the side wall adjacent to an index finger of the user.

6. The device of claim 1, including a first depressable button switch mounted in an upper portion of the side wall adjacent to an index finger of the user.

7. The device of claim 6, including a second depressable button switch mounted in an upper portion of the side wall adjacent to a middle finger of the user.

8. The device of claim 1, including a scroll wheel mounted in an upper portion of the side wall adjacent to an index finger of the user, and a first depressable button switch mounted in the side wall above the scroll wheel, and a second depressable button switch mounted in the side wall below the scroll wheel.

9. The device of claim 1, including a depression formed in the side wall surrounding the pointing member configured to accept at least a portion of the user's thumb therein.

10. The device of claim 1, including finger depressions formed in the side wall and positioned and configured to receive at least a portion of the user's fingers therein.

11. A portable and ergonomic computer cursor control and input device, comprising:
a base;
a generally deformed, substantially cylindrical side wall extending upwardly from the base, the side wall being dimensioned and contoured to enable a palm of a user to be disposed substantially vertical with respect to the base such that the user's fingers form a generally vertical stack with the index finger at a top thereof and the little finger at a bottom thereof when the side wall is grasped by the user;
a track ball for moving the cursor operably mounted in the side wall adjacent to the user's thumb;
a scroll wheel operably mounted in the side wall adjacent the user's index finger and adapted to move the cursor in an up and down movement; and
at least one depressable button operably mounted in the side wall;
whereby the hand and wrist of the user is maintained in a relaxed, untwisted and naturally upright position.

12. The device of claim 11, wherein the base is substantially planar flat for supporting the device on a flat horizontal surface.

13. The device of claim 11, wherein the device is configured for wireless communication with a computer.

14. The device of claim 11, wherein the at least one depressable button comprises a first depressable button switch mounted in the side wall above the scroll wheel, and a second depressable button switch mounted in the side wall below the scroll wheel.

15. The device of claim 11, including a depression formed in the side wall surrounding the track ball configured to accept at least a portion of the user's thumb therein.

16. The device of claim 11, including finger depressions formed in the side wall and positioned and configured to receive at least a portion of the user's fingers therein.

17. A portable and ergonomic computer cursor control and input device, comprising:
a substantially planar flat base for supporting the device on a flat horizontal surface;
a generally deformed, substantially cylindrical side wall extending upwardly from the base, the side wall being dimensioned and contoured to enable a palm of a user to be disposed substantially vertical with respect to the base such that the user's fingers form a generally vertical stack with the index finger at a top thereof and the little finger at a bottom thereof when the side wall is grasped by the user;
a track ball for moving the cursor operably mounted in the side wall adjacent to the user's thumb;
a scroll wheel operably mounted in the side wall adjacent the user's index finger and adapted to move the cursor in an up and down movement;
a first depressable button switch mounted in the side wall above the scroll wheel; and
a second depressable button switch mounted in the side wall below the scroll wheel;
whereby the hand and wrist of the user is maintained in a relaxed, untwisted and naturally upright position.

18. The device of claim 17, wherein the device is configured for wireless communication with a computer.

19. The device of claim 17, including a depression formed in the side wall surrounding the track ball configured to accept at least a portion of the user's thumb therein.

20. The device of claim 17, including finger depressions formed in the side wall and positioned and configured to receive at least a portion of the user's fingers therein.
